(19) United States
(12) Patent Application Publication
(10) Pub. No.: US 2009/0012875 A1
(43) Pub. Date: Jan. 8, 2009

(54) METHOD AND SYSTEM FOR FACILITATING COMMERCIAL TRANSACTIONS USING AUTOMATIC VIRTUAL CURRENCY

(76) Inventors: Valerio ZANINI, Ponte Vedra Beach, FL (US); Jonathan Dugan, College Park, MD (US)

Correspondence Address: ARENT FOX LLP, 1050 CONNECTICUT AVENUE, N.W., SUITE 400, WASHINGTON, DC, 20036, US

(21) Appl. No.: 12/168,421

(22) Filed: Jul. 7, 2008

Related U.S. Application Data
(60) Provisional application No. 60/929,604, filed on Jul. 5, 2007.

(51) Int. Cl. G06Q 30/00; G06Q 40/00

(52) U.S. Cl. 705/26; 705/37

(57) ABSTRACT

Provided are methods and systems for facilitating commercial transactions, such as sales, trades, or barters, using a virtual currency value. A data repository containing a list of available items is created and updated. A virtual value is assigned to each item in the data repository. Upon a match between an offer and a request for an item, the virtual value of the item is deducted from the buyer's account, and is added to the seller's account.

### RELATED APPLICATIONS

This application claims the benefit of U.S. Provisional Application No. 60/929,604 titled METHOD AND SYSTEM FOR FACILITATING COMMERCIAL TRANSACTIONS USING AUTOMATIC VIRTUAL CURRENCY filed Jul. 5, 2007, the entirety of which is incorporated by reference herein.

### BACKGROUND OF THE INVENTION

1. Field of the Invention

The present invention relates to methods and systems for facilitating commercial transactions, such as sale, trade, or barter, using a virtual currency value. Specifically, the present invention relates to an innovative peer-to-peer trading method and system for goods, which allow users of a computer network, such as the Internet, to trade or barter goods and/or services. The present invention is based on an open system architecture that has two basic components. The first component assigns a virtual currency value to each traded item (e.g., goods and/or services), and allows all users to trade at that value. The second component is an automatic queuing system that prioritizes all offers and requests, and allows users to initiate a transaction automatically and with minimum effort.

2. Background of the Related Art

There are known in the art online systems that allow buying, selling, or trading goods and/or services online. These systems, however, have always requested the users to provide and/or review a large amount of information in order to both present an item for sale or trade, and to initiate the sale or trade. Users often must provide a description of the item for sale or trade, along with an indication of the price and availability. Furthermore, users may be required to search for available offers, to contact other parties to discuss the terms of the transaction, or to negotiate the price. All these activities require time and effort from both the seller and the buyer to complete a transaction.

There is a need in the art, therefore, for methods and systems that allow initiating and performing online commercial transactions without requiring a large amount of information and effort on behalf of a seller and/or buyer.

### SUMMARY OF THE INVENTION

Aspects of the present invention addresses the above identified needs, as well as others, by reducing the effort necessary to complete a transaction and by standardizing the currency value of each item so as to avoid unnecessary negotiations among users. Aspects of the present invention provide methods for automatically initiating a transaction between a seller and a buyer based on characteristics of the seller's offer and the buyer's request. Aspects of the present invention offload the need to fix a price for each item by assigning a virtual value to each item based on an internal algorithm that reflects, e.g., a fair market value. Furthermore, aspects of the present invention manages offers and requests using a queuing system to ensure that offers and requests for a transaction are served in the order of their creation in the system.

The present invention supports, but is not limited to, physical and virtual goods such as video games, music CDs, video DVDs or books, and can be extended to other goods and/or services using the same principles.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 presents an example of an open system architecture, in accordance with aspects of the present invention;

FIG. 2 shows a flowchart of a method for calculating the virtual value of an item, in accordance with aspects of the present invention;

FIGS. 3A and 3B show the format of an OfferQueue and RequestQueue, respectively, in accordance with aspects of the present invention;

FIG. 4 shows the format of a transaction, in accordance with aspects of the present invention;

FIG. 5 shows the states of an offer, in accordance with aspects of the present invention;

FIG. 6 shows the states of a request, in accordance with aspects of the present invention;

FIG. 7 shows the states of a transaction, in accordance with aspects of the present invention;

FIG. 8 presents an exemplary system diagram of various hardware components and other features, for use in accordance with aspects of the present invention;

FIG. 9 is a block diagram of various exemplary system components, in accordance with aspects of the present invention;

FIGS. 10A-10J present exemplary Graphic User Interface (GUI) screens, in accordance with aspects of the present invention; and

FIG. 11 provides a flowchart of a method for online trading of goods and/or services, in accordance with aspects of the present invention.

### DETAILED DESCRIPTION OF THE INVENTION

It is an object of this invention to provide an electronic system that facilitates trades of goods and/or services among users of a computer network, such as Internet, by assigning a virtual currency value to each item available for trading. The system supports, but is not limited to, physical goods such as video games, music CDs, video DVDs or books, and can be extended to other goods and/or services using the same principles. Virtual goods can also be traded using the system, as long as there is a method or legal enforcement mechanism that allows transferability of title or licensing to users.

In accordance with one variation, the present invention may be operated and managed on an online computer system that can be accessed remotely by each user through a computer network connection such as Internet. It may be based on an application that receives user data and commands, and respectively provides results to users (a web server), and on a central repository of all data used to describe the items, the transactions and user details (e.g., a database or other repository). Any combination of a web server and database model can be used to build this system as long as it satisfies the minimum requirements for its functionality.

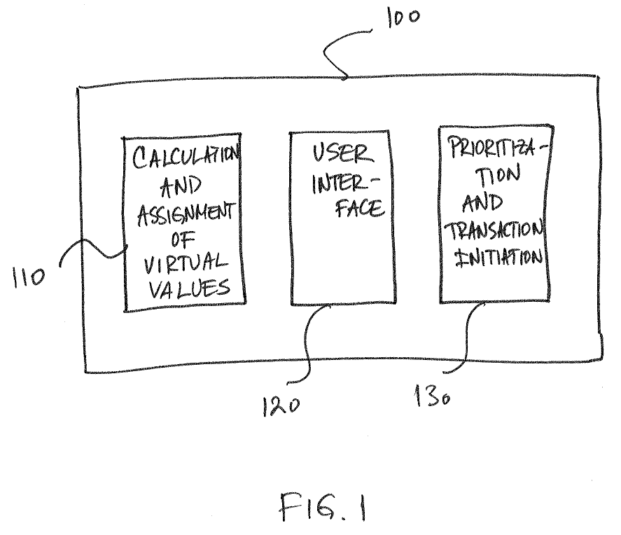

Referring now to FIG. 1, therein shown is open system architecture 100, in accordance with one variation of the present invention, comprised of three main components. The first component is Calculation and Assignment of Virtual Values Module 110, which assigns a virtual value to each individual item, for use as the trading price for a transaction. The second component is User Interface 120, which allows users to insert their offers and requests, and to define the general characteristics of the items they are offering or requesting. The third component is Prioritization and Transaction Initiation Module 130, which enables listing, prioritizing, and selecting the offers and requests for a transaction, and initiates transactions.

### Calculation and Assignment of Virtual Values Module 110

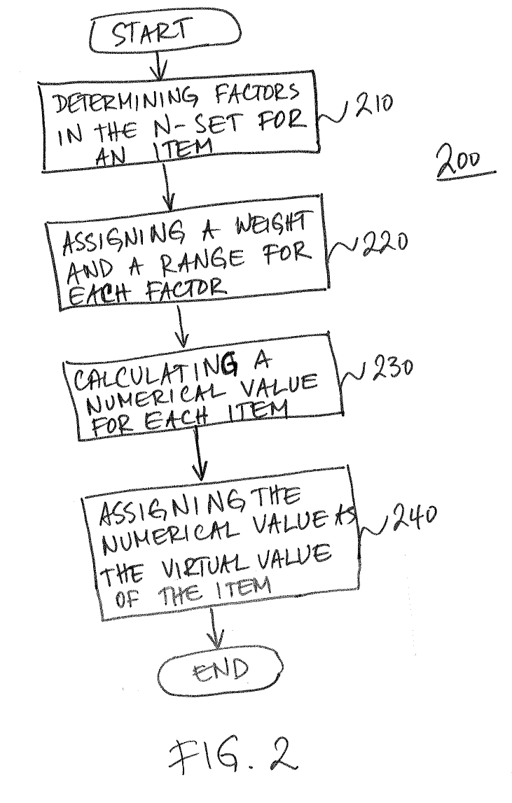

The Calculation and Assignment of Virtual Values Module 110 may comprise, for example, an algorithm that calculates and assigns to each individual item a virtual value that is used as the trading price for a transaction. This algorithm allows the system to integrate the other components together, and to provide users with an easy and seamless experience. In accordance with one variation of the present invention, a method for calculating the virtual value of an item is shown in FIG. 2.

In general, each item is sold new at retail at a price that is usually equal to, or close to, the Manufacturer Suggested Retail Price (MSRP), which is the recommended price for selling the new item at retail. After the item has been bought and used, the item may be resold in the used market at a value that may be very different from its original MSRP. It may be lower or higher than the MSRP depending on several factors (including demand, supply, general condition, quality, and rarity). In general, the value at which the item is sold in the used market is referred to as the fair market value of the item.

Aspects of the present invention create a virtual market with the purpose of simulating the value of each item in the used market. Users buy and sell goods in the virtual market using a virtual currency. The prices of the goods are set by the system, taking in consideration intrinsic factors of the virtual market such as demand and supply for each item on the virtual market. The method is designed to adapt the value of each item over time to the varying conditions in the virtual market.

The system uses the virtual currency to facilitate trades between users, and to simplify the trading process. The virtual currency can be represented as cash, points or a fake currency used only inside the system. However, in accordance with one variation, the virtual value assigned to each item in the virtual market should be fairly proportional to the fair market value of each item in the real used market.

The purpose of the method, in accordance with aspects of the present invention, is to make the best approximation of an item's fair market value in the real used market using a set of factors that define the virtual market. The algorithm may use a set of parameters to determine the best approximation of the fair market value for each item. This set of parameters can be defined as an n-set of n factors. Each factor in the n-set has a different meaning and relates to a different dimension that affects the virtual market. The n-set can be seen as a plane of n-dimensions in an n-space. By assigning a value to each of the n dimensions, the position of the n-set in the n-space, and a virtual value in the virtual market, may be determined.

The n-set may be composed of the following factors, among others: (a) the current MSRP of the item on sale as new at retail; (b) the age of the item based, e.g., on its publication date; (c) the type or genre of the item; (d) the demand for the item in the virtual market; (e) the supply for the item in the virtual market; (f) the rating assigned to the item by the users of the system; and (g) a delta provided by the system administrator to offset any differences between real market value and virtual value, if necessary.

Each of these factors may be assigned a weight and a range, in accordance with aspects of the present invention. The weight represents the relative importance of the factor to determine the overall virtual value. The range determines the maximum variation that each factor may create in the virtual value.

Based on the value of these factors, on their weights and their possible ranges, a numerical value for each item is calculated. The resulting value is considered the virtual value of that item and is associated to the item for user transactions.

In accordance with aspects of the present invention, the virtual value may be calculated using the following general formula:

Virtual value=f{p,pd,r,d,s,a,g} (1)

In formula (1): the price (p) is the price at which the item is sold as new (MSRP); the publication date (pd) is the date the item was released on the market; the rating (r) is the average of votes given by users to each item in the system; the demand (d) is an estimated demand for each item requested in the system, and can be assessed on the basis of the “request” list for the item (i.e., how many request exist in the system for the item); the supply (s) is an estimated supply for each item offered in the system, and can be evaluated from the length of the “offers” list for the item (i.e., how many offers exist in the system for the item); the delta (a) is an additional factor used by administrators to add/subtract value to a specific item; the genre (g) is used to differentiate values for items of different genres or categories.

Formula (1) can also be presented as as:

Virtual value=g*(w₀*p+w₁*pd+w₂*r+w₃*d+w₄*s)+w₅*a (2)

where w₀ to w₅ represent the weights associated with each factor.

For example, a calculation of each factor and associated weight, included in the Virtual value of an item may be performed as follows:

Price (p): formula (2) uses the item's MSRP price to calculate the first component of the formula, w₀*p, where:

w₀=10;

p=MSRP in dollars;

If item's price=0 or Null, then:

w₀*p=320 [average price*10]

Publication date (pd): the publication date of an item is used to evaluate how long the item has been on sale on the market:

Age=Today_date−Publication_date

Based on the value of Age, the associated weight w₁*pd may be assigned based on the following table:

| Age | | Component w₁*pd |
|---|---|---|
| <3 | months | 200 |
| 3 to 12 | months | 100 |
| 12 to 18 | months | 0 |
| 18 to 30 | months | −100 |
| >30 | months | −200 |

Rating (r): users may vote and rate each item's quality. In accordance with aspects of the present invention, the ratings may range in value from 0 to 5. Based on the value of the rating, the value w₂*r in formula (2) may be determined as follows:

w₂*r=(rating−3)*100 (3)

Demand (d): measures how many more item are requested than are offered. The underlying idea is that an item that is requested by many users, e.g., that is in high demand, is more valuable. Therefore, the demand component assigns a higher value to items that have a comparably longer request list. Thus, for a given item, we the demand may be calculated as follows:

Demand=(number of entries for that item in “Requests” list in status “Active”)−(number of entries for that item in “Offers” list in status “Active”) (4)

Demand is considered only when it is greater than 0 (i.e., there are more entries in “requests” than in “offers”). The component may be calculated as follows:

w₃=10

w₃*d=Demand*10(max value 200),

where:

w₃*d is either a positive component or zero; and

w₃*d has values in the range [0, 200].

Supply (s): supply is the opposite of Demand, as it may be measured by how many more items are offered than requested. The underlying idea is that an item that is offered by many users, but not requested as much, is less valuable. Therefore, the supply component assigns a lower point value to games that have a comparably longer offer list.

For a given item, supply may be calculated as follows:

Supply=(number of entries for that item in “Offers” list in status “Active”)−−(number of entries for that item in “Request” list in status “Active”) (5)

Supply is considered only when it is greater than zero (i.e., there are more entries in “Offers” than in “Requests”). The component may be calculated as follows:

w₄=10

w₄*s=−(Supply*10), (min value−200)

where:

w₄*s is either a negative component or zero; and

w₄*s has values in the range [−200, 0].

Administrator value (a): the system administrator can give a bonus and/or penalty to specific items to adjust the virtual value to the “real” value in the market. This is a value that the administrator can set at will as a constant for each specific item:

w₅*a=constant

Genre (g): this may be used as a scaling factor to adapt the range of values for items of different genre or category. For example, the default value may be set to:

g=1

All the factors considered in the formula represent unique and fundamental dimensions that need to be considered to find a good simulation of the fair market values in the used market for the item values in the virtual market.

All virtual values of the items are re-calculated on a periodic schedule to adapt the values to changing conditions (i.e. varying supply and demand, aging of an item, rating from users), and to make sure that the virtual values always provide a good simulation of the fair market value of each item in the used market.

### User Interface 120

Referring again to FIG. 1, the second component of open system architecture 100, the User Interface 120, allows users to insert their offers and requests, and to define the general characteristics of the items they are offering or requesting.

Once users are recognized and logged into the system, e.g. using unique credentials, they can provide a list of items available for trading in an “offers” list, and a list of items they are requesting in a “requests” list.

In accordance with aspects of the present invention, the system offers a list of all items that are authorized for trading from an extensive database of information, and allows users to choose from this list the items that they own and want to trade, or those they wish to request. The system may provide several methods for users to search for their items in the database and add them to the “offers” or “requests” list, such as: browsing by title, browsing by category, browsing by genre, free text search on the title, searching the Uniform Product Code (UPC) of a specific item, or searching in the list of all items already available for trading from other users.

In accordance with aspects of the present invention, when a user adds an item to the “offers” or “requests” list, the user has the possibility to specify additional characteristics of the item, selected from a pre-defined pool of options. These options include the condition of the item (e.g., new, used, excellent, poor) and completeness (e.g., case, manual, and original media or disc available). The system will then search for offers and requests that match compatible options to initiate a transaction between users.

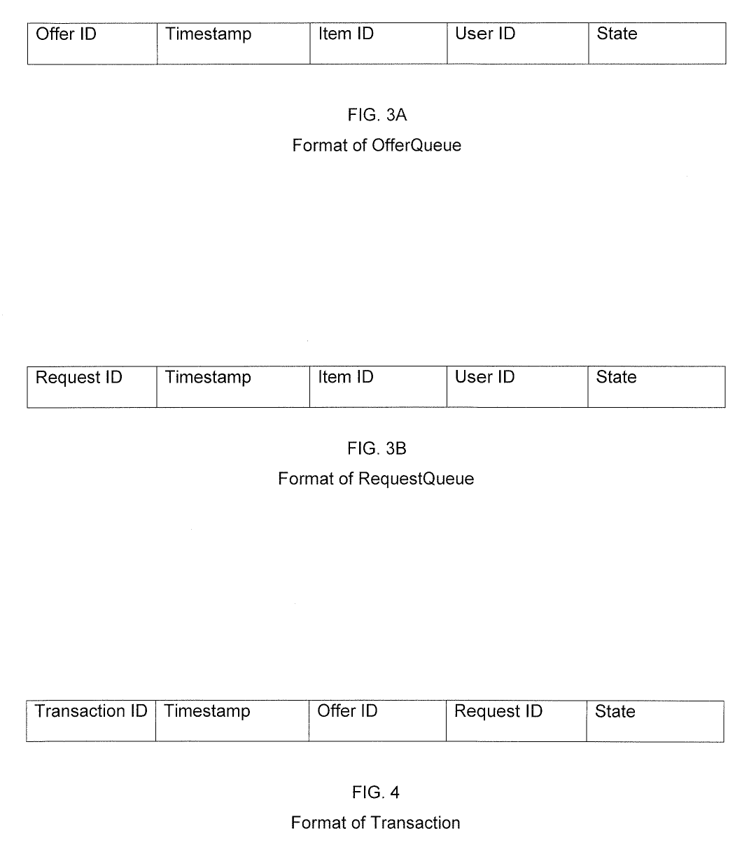

Once the user has completed describing the item, the system puts the offer or request into a database where all the information is stored, for later retrieval. If the user has inserted an item in the “Offers” list, the system will create a corresponding entry for that item in the OffersQueue table, a shown in FIG. 3A. If the user has inserted an item in the “Requests” list, the system will create a corresponding entry for that item in the RequestsQueue table, as shown in FIG. 3B. The tables shown in FIGS. 3A and 3B store the offers and requests information for each user.

### Prioritization and Transaction Initiation Module 130

Referring again to FIG. 1, the third component of the open system architecture 100 is Prioritization and Transaction Initiation Module 130, which enables listing, prioritizing, and selecting the offers and requests for a transaction, and initiates transactions.

In accordance with aspects of the present invention, a “first in, first out” (FIFO) prioritization approach is employed, in which older requests and/or offers are selected first for a transaction than newer ones. In order to achieve a FIFO queuing system it is necessary to establish a method to store the order in which the items are inserted in the system as offers or requests.

Associated to each entry in the “Offers” or “Requests” lists, the system may store a “timestamp” value, or the exact date and time the offer or request has been inserted, as also shown in Tables 1A and 1B. This information may be used to order and prioritize the offers and requests, as the list for each individual item can be sorted based on the timestamp which corresponds to the order of insertion into the list. Therefore, based on the timestamp value, each item is assigned an order—and therefore a priority position—in the FIFO queue.

At periodic intervals the system browses through the “Offers” and “Requests” lists for each item looking for compatible or matching items. The search follows the order and priority defined by the timestamp; older items are selected first, then newer ones.

If a matching offer and request are found, the system stores information about the two and creates a “Transaction” between the user offering the item for sale and the user requesting the item for purchase, as shown in FIG. 4. The Transaction object in the database is used to manage the transaction between the two users from its start to completion.

Once the transaction is initiated, the seller (user offering the item for sale) is contacted using, e.g., an electronic message, and is informed that the item has been selected for a trade. The seller can then proceed to accepting the trade and shipping the item to the buyer (i.e., the user requesting the item for trade). The buyer is also informed, e.g., using an electronic message, that the seller has accepted the transaction and has agreed to ship the item, if appropriate, and pays the virtual price of the item into, e.g., an escrow account in the system, such as a bank account or other arrangement.

Once the buyer receives the item, the buyer can provide feedback on the transaction, and confirm receipt of the item. Upon the buyer confirming receipt of the item, the virtual payment is transferred from the escrow account to the seller's account, and the transaction is completed.

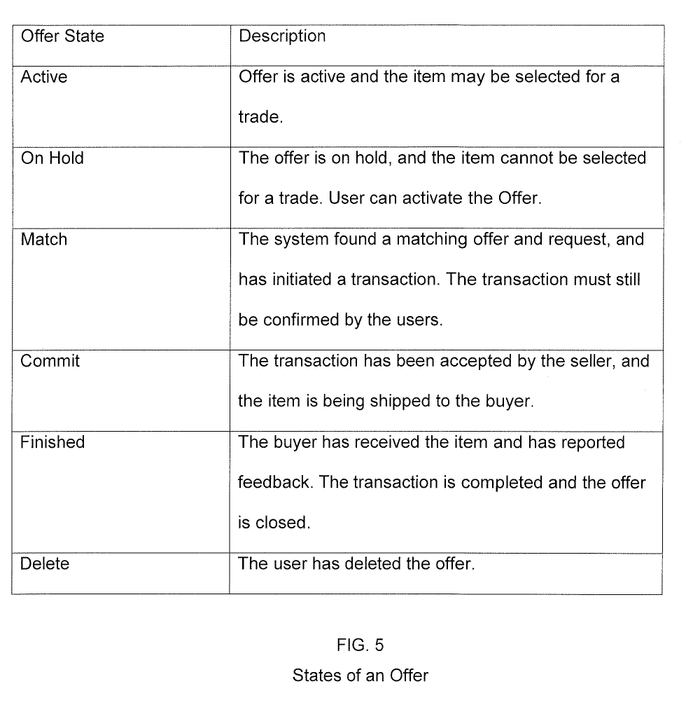

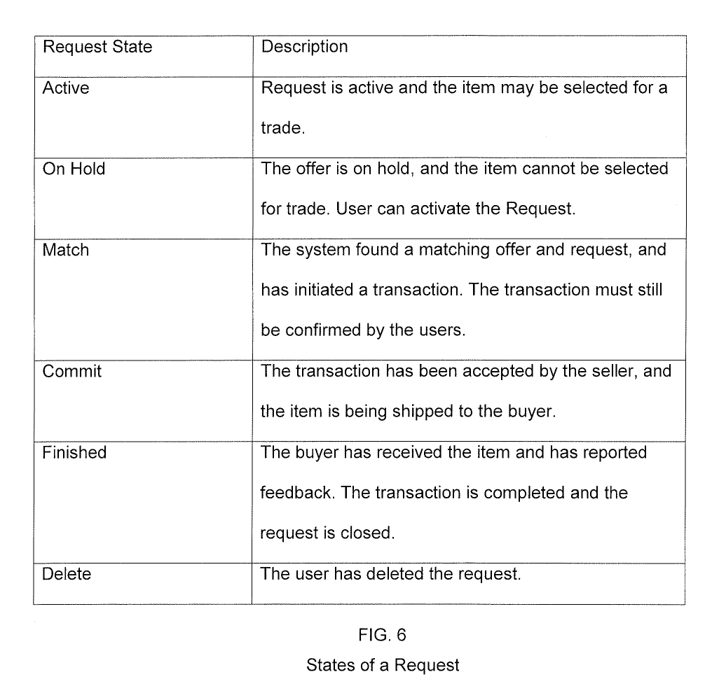

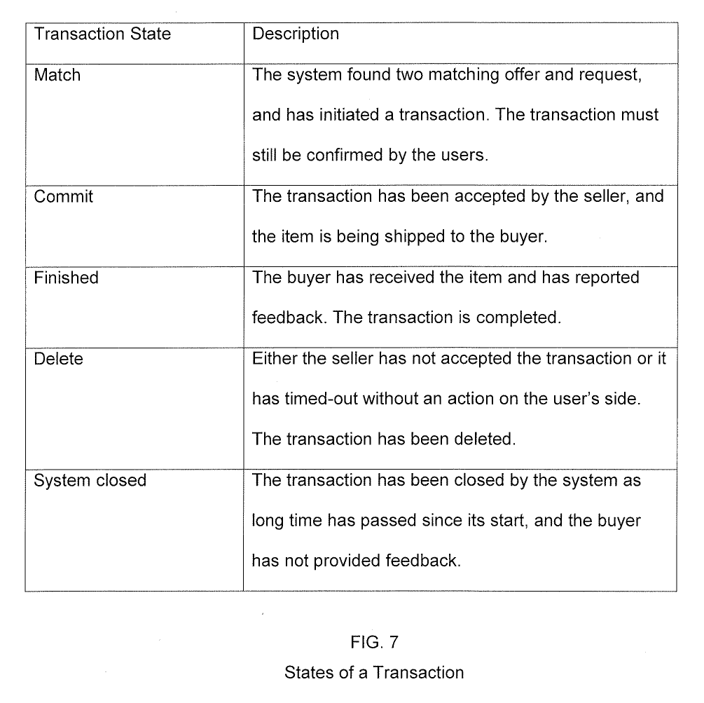

FIGS. 5, 6 and 7 show how the states of a Request (FIG. 5), an Offer (FIG. 6) and a Transaction (FIG. 7) vary over time as the trade progresses.

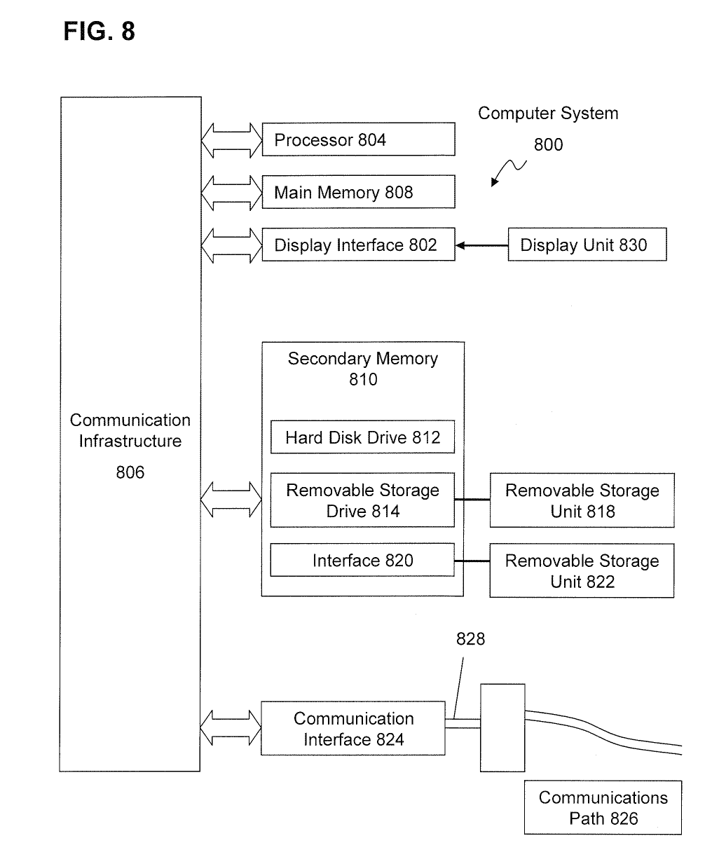

The present invention may be implemented using hardware, software, or a combination thereof and may be implemented in one or more computer systems or other processing systems. In one variation, the invention is directed toward one or more computer systems capable of carrying out the functionality described herein. An example of such a computer system 800 is shown in FIG. 8.

Computer system 800 includes one or more processors, such as processor 804. The processor 804 is connected to a communication infrastructure 806 (e.g., a communications bus, cross-over bar, or network). Various software aspects of the present invention are described in terms of this exemplary computer system. After reading this description, it will become apparent to a person skilled in the relevant art(s) how to implement the invention using other computer systems and/or architectures.

Computer system 800 can include a display interface 802 that forwards graphics, text, and other data from the communication infrastructure 806 (or from a frame buffer not shown) for display on a display unit 830. Computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well-known manner. Removable storage unit 818, represents a floppy disk, magnetic tape, optical disk, etc., which is read by and written to removable storage drive 814. As will be appreciated, the removable storage unit 818 includes a computer usable storage medium having stored therein computer software and/or data.

In alternative variations, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as that found in video game devices), a removable memory chip (such as an erasable programmable read only memory (EPROM), or programmable read only memory (PROM)) and associated socket, and other removable storage units 822 and interfaces 820, which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824 are in the form of signals 828, which may be electronic, electromagnetic, optical or other signals capable of being received by communications interface 824. These signals 828 are provided to communications interface 824 via a communications path (e.g., channel) 826. This path 826 carries signals 828 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 880, a hard disk installed in hard disk drive 870, and signals 828. These computer program products provide software to the computer system 800. The invention is directed to such computer program products.

Computer programs (also referred to as computer control logic) are stored in main memory 808 and/or secondary memory 810. Computer programs may also be received via communications interface 824. Such computer programs, when executed, enable the computer system 800 to perform the features of the present invention, as discussed herein. In particular, the computer programs, when executed, enable the processor 810 to perform the features of the present invention. Accordingly, such computer programs represent controllers of the computer system 800.

In accordance with one variation, in which the invention is implemented using software, the software may be stored in a computer program product and loaded into computer system 800 using removable storage drive 814, hard drive 812, or communications interface 820. The control logic (software), when executed by the processor 804, causes the processor 804 to perform the functions of the invention as described herein. Another variation is implemented primarily in hardware using, for example, hardware components, such as application specific integrated circuits (ASICs). Implementation of the hardware state machine so as to perform the functions described herein will be apparent to persons skilled in the relevant art(s).

In yet another variation, aspects of the present invention are implemented using a combination of both hardware and software.

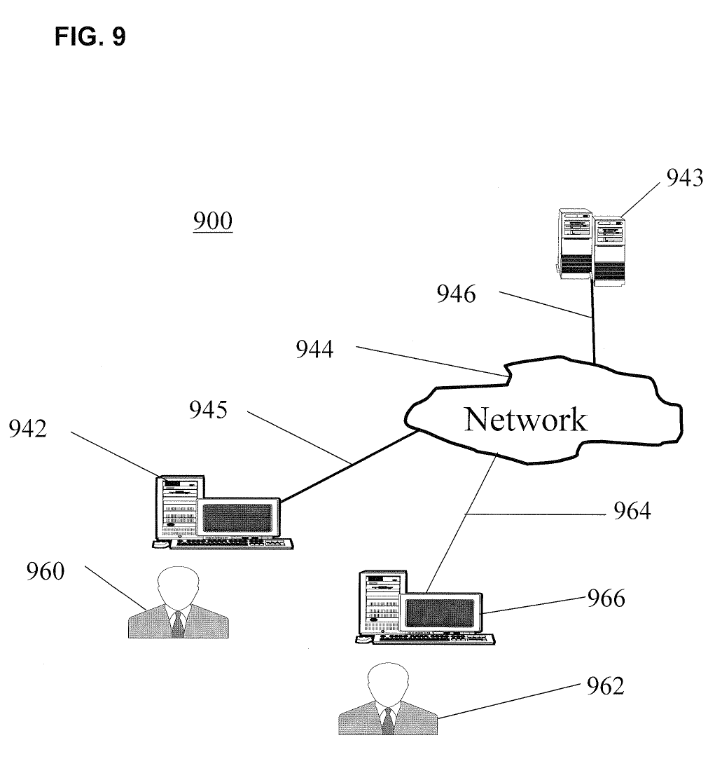

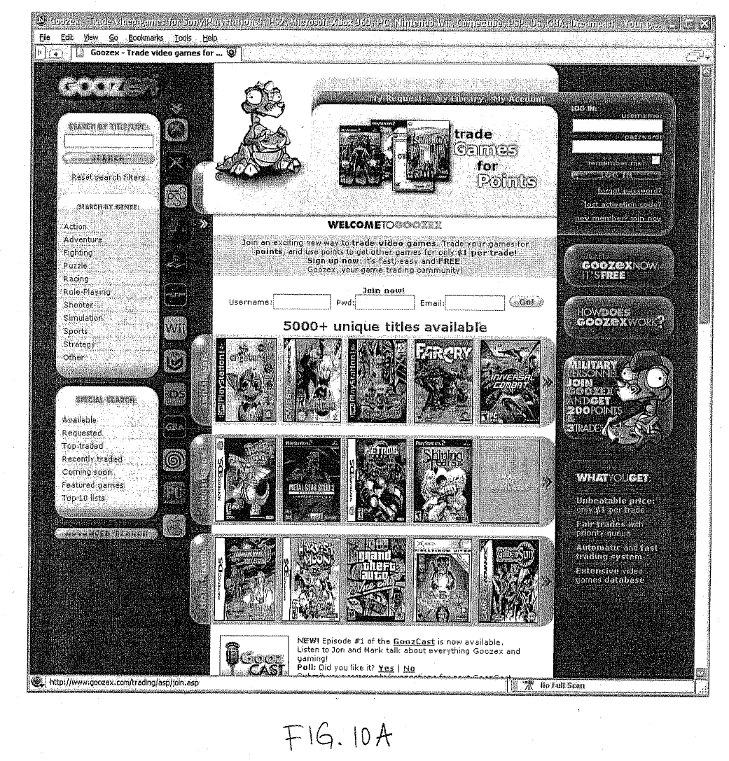

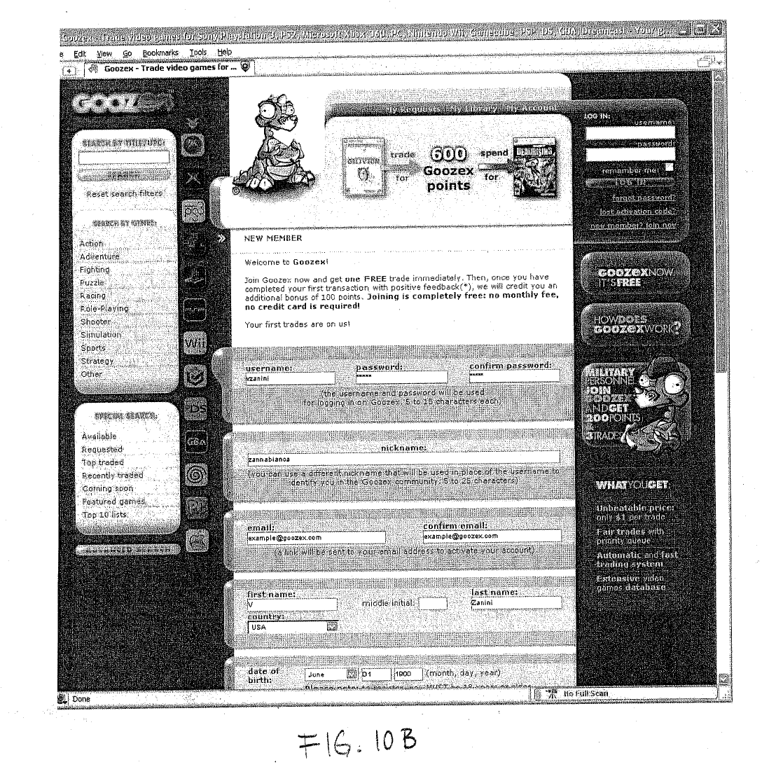

FIG. 9 shows a communication system 900 usable in accordance with the present invention. The communication system 900 includes one or more accessors 960, 962 (also referred to interchangeably herein as one or more “users”) and one or more terminals 942, 966. Data for use in accordance with aspects of the present invention is, for example, input and/or accessed by accessors 960, 964 via terminals 942, 966, such as personal computers (PCs), minicomputers, mainframe computers, microcomputers, telephonic devices, or wireless devices, such as personal digital assistants (“PDAs”) or a hand-held wireless devices coupled to a server 943, such as a PC, minicomputer, mainframe computer, microcomputer, or other device having a processor and a repository for data and/or connection to a repository for data, via, for example, a network 944, such as the Internet or an intranet, and couplings 945, 946, 964. The couplings 945, 946, 964 include, for example, wired, wireless, or fiberoptic links. In another variation, the method and system in accordance with aspects of the present invention operate in a stand-alone environment, such as on a single terminal.

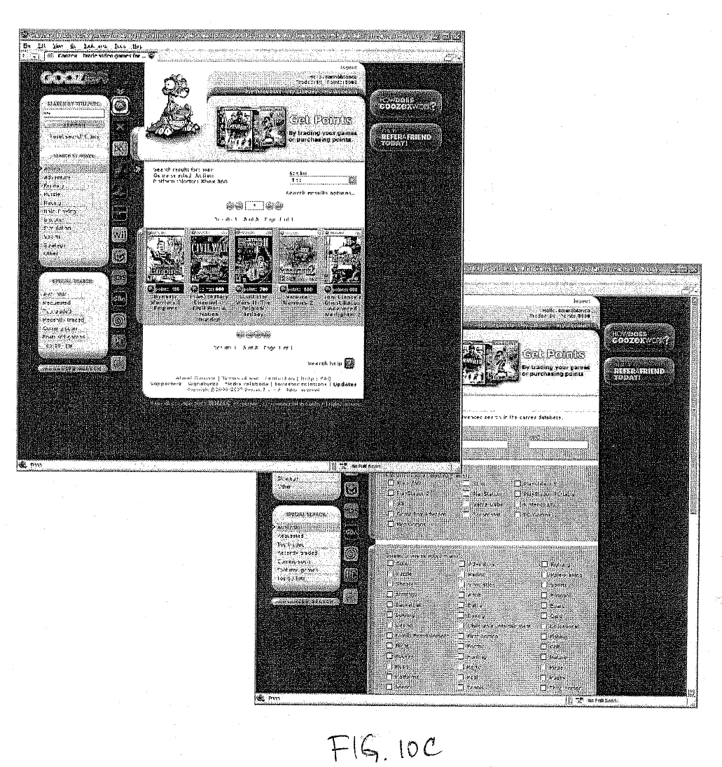

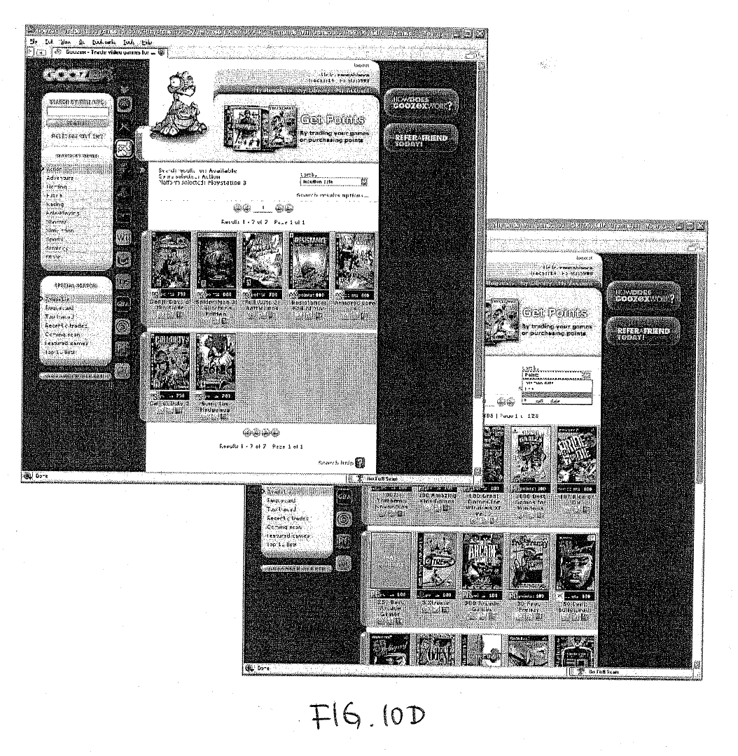

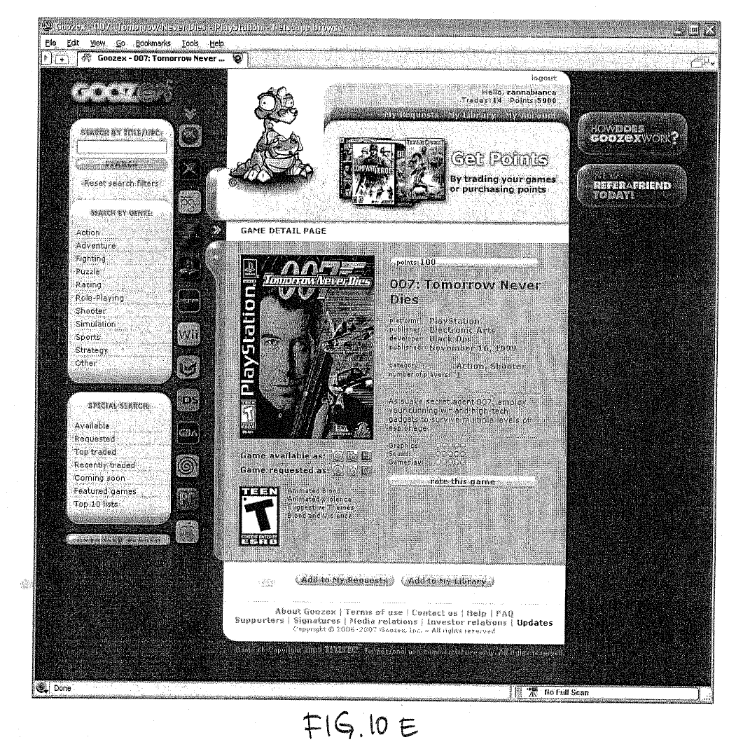

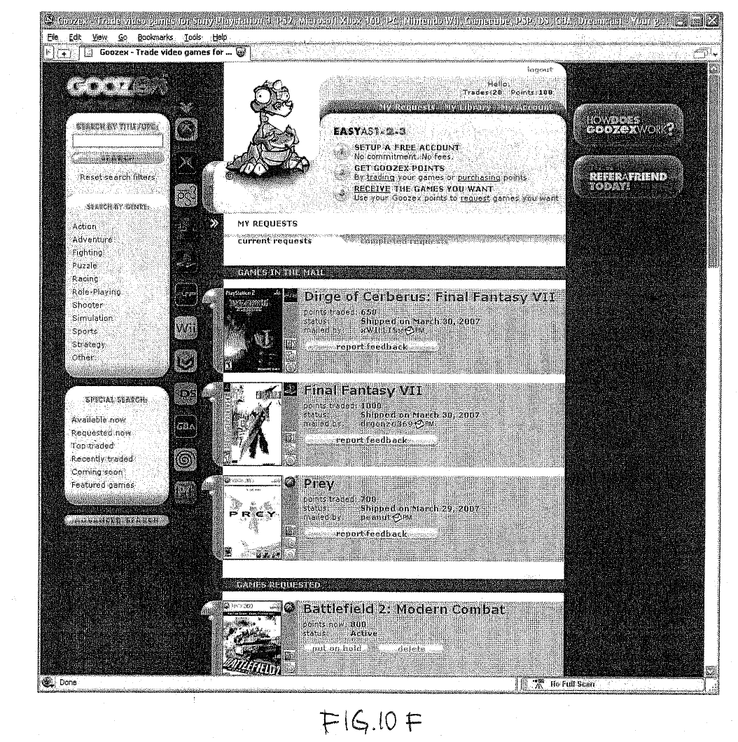

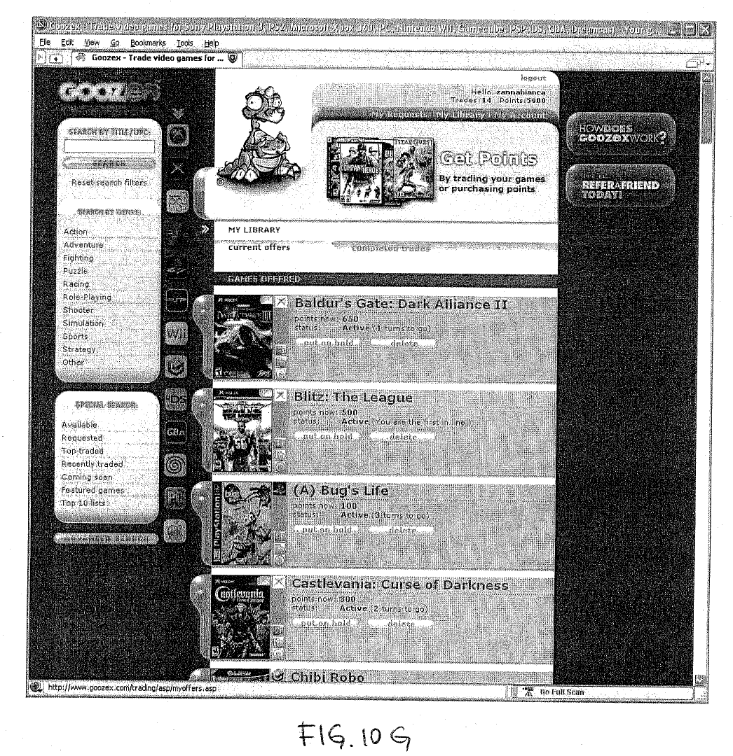

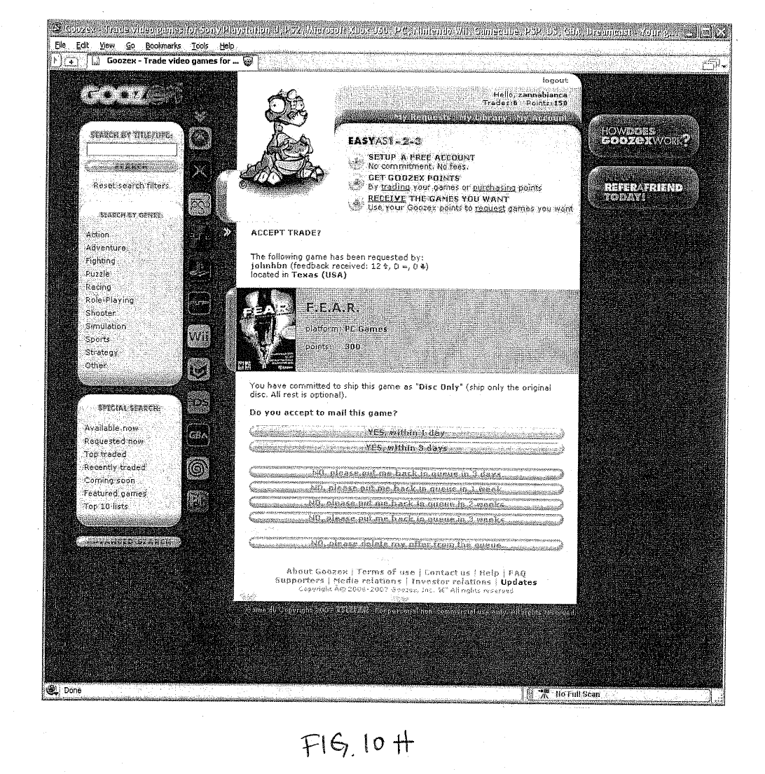

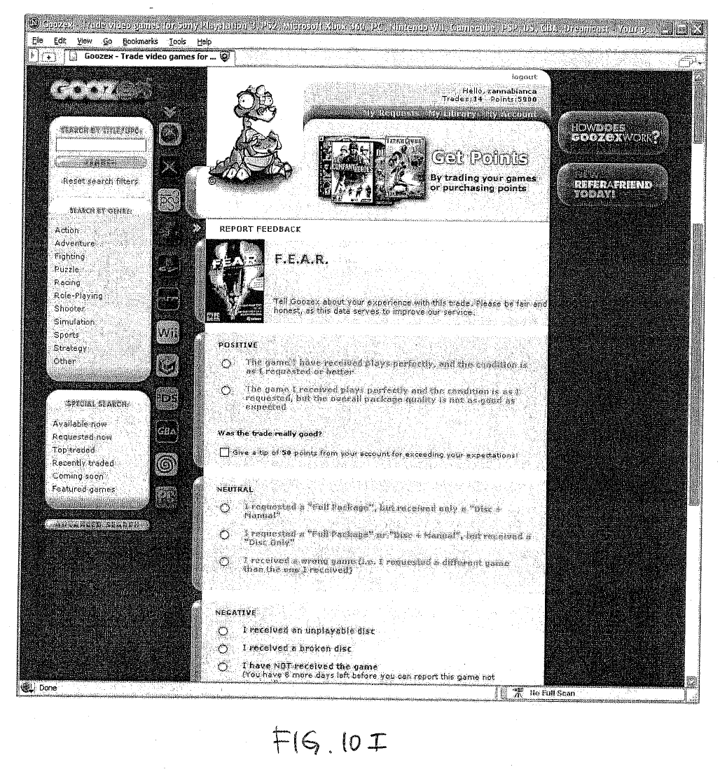

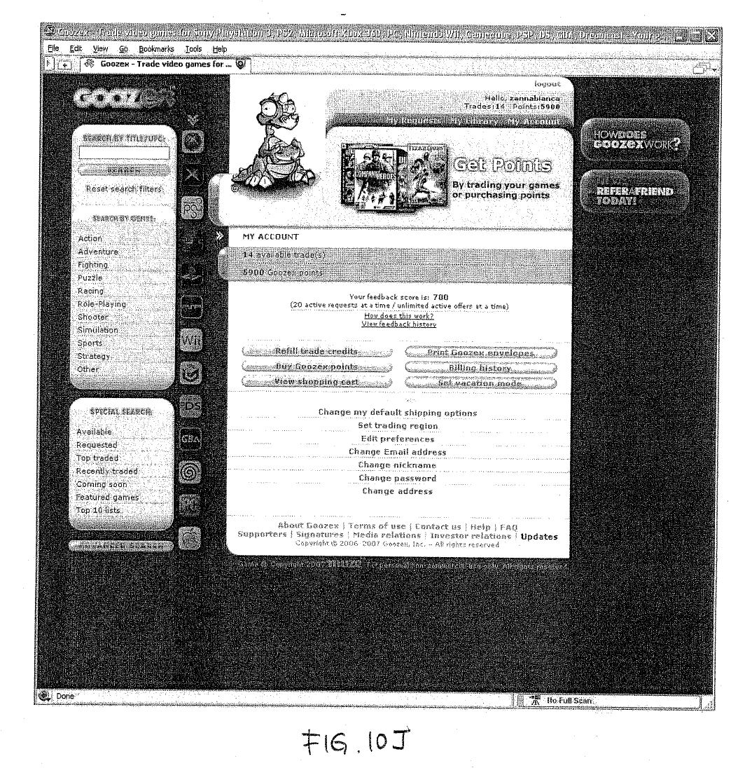

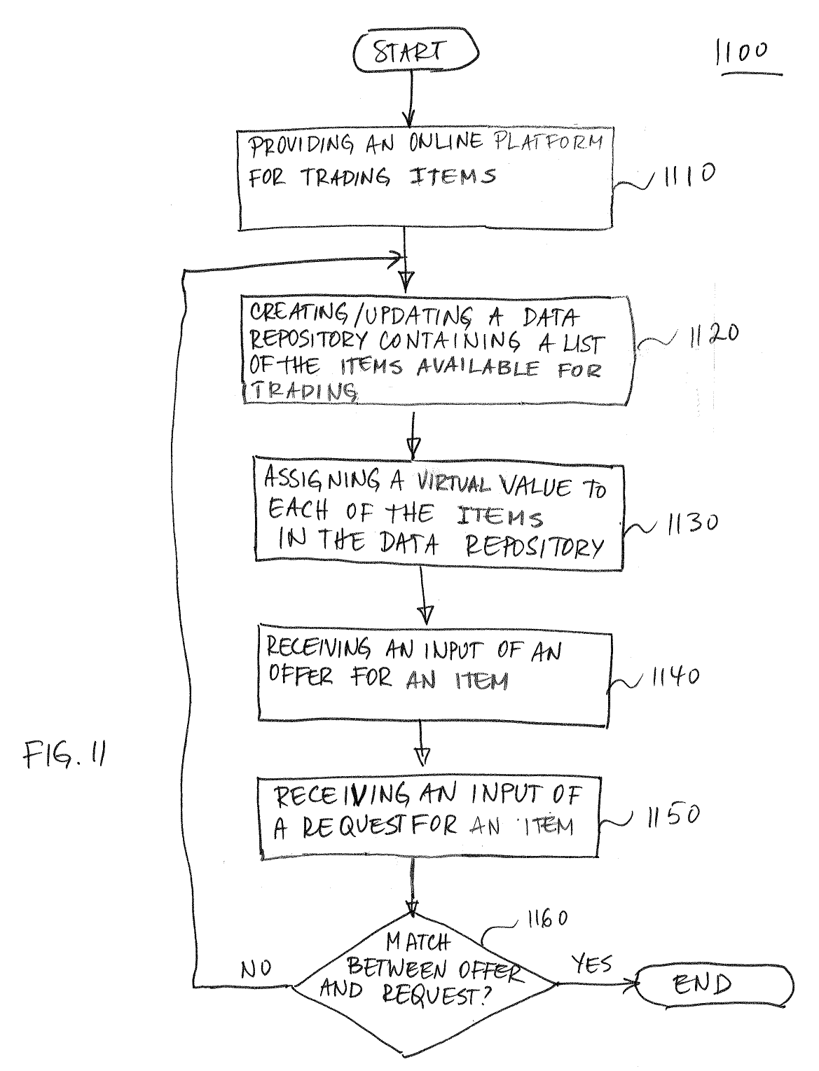

Referring now to FIGS. 10A-10J, therein shown are exemplary GUI screens, in accordance with aspects of the present invention. Specifically, FIGS. 10A-10M illustrate a variation of the present invention related to an online game trading system based on a virtual currency. In accordance with aspects of the present invention, users of the system may connect online and trade games with other users for points. One variation of the present invention, a virtual value that is, e.g., proportional to the fair market value of the game in the used game market, is assigned to each game. In addition, in accordance with aspects of the present invention, two or more lists a created. For example, a first list may be titled “My Offers,” and a second list may be titled “My Requests.” In accordance with aspects of the present invention, matches are created between offers and requests, and a connection may be provided between the respective offerors and requestors to initiate a trade. Upon completion of the trade, points may be added to the offeror's account and deducted from the requestor's account, for example. In accordance with aspects of the present invention, the offerror may use the added points used for trading other games with other users.

FIG. 10A shows an exemplary GUI home page, from which users may browse a library of games for more information, or can click on, or otherwise select, “Join Now!” to activate a new user account, in accordance with aspects of the present invention.

FIG. 10B shows an exemplary GUI screen for activation of a new account, in accordance with aspects of the present invention. Fraud prevention security measures may be implemented. For example, upon a new user providing the requested data on the activation screen, an e-mail may be sent to the new user containing an activation code. Upon clicking or otherwise selecting the activation code, the new user's account may be confirmed and the user is provided with access to all areas of the web-site.

FIG. 10C shows an exemplary search page GUI screen, available to users browsing the database of available games. In the example shown in FIG. 10C, a search is conducted for a game containing the word “war” in the section of “action” games for the platform Xbox 360™. Searching may be performed by free text, genre, special search, and platform, taken alone or in combination, among other search options.

FIG. 10D shows an exemplary search page GUI screen. This example shows that users may browse the list of games, currently offered or requested for trading. The list of games may be sorted by title, points and/or publication date, among other sort factors, and may contain an indication of the condition of the game that is being offered or requested, such as “disc only,” “disc+manual,” or “full package.” Further, in accordance with aspects of the present invention, users may browse the lists of games offered or requested in real time, by clicking or otherwise selecting the “Available” or “Requested” tabs.

FIG. 10E shows an exemplary game detail page. In accordance with aspects of the present invention, upon clicking or otherwise selecting the game icon of any game, a game detail page showing specific information about the game is provided. A user may be presented with options to select the game as one of the user's requests or offers.

FIG. 10F shows an exemplary GUI screen of a user request list. In accordance with aspects of the present invention, the exemplary screen includes a “Games in the mail” section showing the games that are currently being shipped to the user, and a “Games requested” section, showing all games requested by the user that have not yet been confirmed by other users.

FIG. 10F shows an exemplary GUI screen of the list of games a user has available for trading with other users.

FIG. 10H shows an exemplary GUI screen of a trade confirmation page, in accordance with aspects of the present invention. Upon matching an offer for a game with a request, the offeror may be contacted, e.g., via an e-mail, with a request to accept the trade. The offeror may have options to accept the trade and ship the game to the requester, to decline the trade, or to delay the trade by a specified period of time, among other options. According to aspects of the present invention, if an offeror accepts a trade, the offeror is provided with information about the requester, such as address information and/or a pre-addressed packaging label indicating where the game is to be shipped (e.g., the requestor's home address or third party address).

FIG. 10 I shows an exemplary feedback page, in accordance with aspects of the present invention. For example, upon shipping of a game, the intended recipient may be provided with a “Report feedback” option, upon selecting which the recipient may provide feedback about the trade when the game is received, or if it is not received. Among other option, feedback may be positive, negative or neutral. In the case of negative feedback, the recipient may be provided with refund points. In accordance with one variation, the feedback may be placed in the seller's file, and may be used to assess the seller's credibility.

FIG. 10J shows an exemplary user account page, in accordance with aspects of the present invention. The user account page may include all information about the user's account, including, without limitation: details on points and trades available; trading history; option to purchase points; option to change preferences and user data (e.g., address and e-mail); and option to activate vacation mode, when the user will be unavailable for an extended period of time.

Referring now to FIG. 11, therein shown is a flowchart of a method 1100 for online trading of goods and/or services, in accordance with aspects of the present invention. An online platform for trading items is provided 1110. A data repository containing a list of items available for trading is created and/or updated 1120. A virtual value is assigned for each item 1130. An input of an offer for an item is received 1140. An input of a request for an item is received 1150. Upon a match between the offer and request 1160, establishing contact between the offeror and the requester.

Aspects of the present invention being thus described in terms of several variations and illustrative examples, it will be obvious that the same may be varied in many ways. Such variations are not to be regarded as a departure from the spirit and scope of the described aspects, and to incorporate such modifications as would be obvious to one skilled in the art.

1. A method for facilitating online commercial transactions, the method comprising:
creating a data repository containing a list of items;
assigning a virtual value to each item;
receiving an input of an offer for a first item from a seller having a virtual value account;
receiving an input of a request for a second item from a buyer having a virtual value account; and
upon a match between the offer for the first item and the request for the second item, establishing a connection between the seller and the buyer,
wherein the seller's virtual value account is incremented by the virtual value of the item, and the buyer's virtual value account is decreased by the virtual value of the item.

2. The method of claim 1, further comprising:
prioritizing the offer and the request.

3. The method of claim 2, wherein the prioritizing is provided based on a timestamp of the offer and a timestamp of the request.

4. The method of claim 1, the assigning of the virtual value to each item further comprising:
determining factors in an N-set for each item;
assigning a weight and a range for each factor;
calculating a numerical value for each item based on the assigned weights and ranges; and
assigning the calculated numerical value as the virtual value of each item.

5. The method of claim 1, wherein creating the data repository includes updating the data repository.
